(19) United States
(12) Patent Application Publication
(10) Pub. No.: US 2006/0190524 A1
(43) Pub. Date: Aug. 24, 2006

(54) Method and system for an electronic agent traveling based on a profile

(76) Inventors: Erik Bethke, Laguna Woods, CA (US); Nathaniel Simpson, Groveport, OH (US); Raymond F. Ratcliff III, Austin, TX (US)

Correspondence Address: DENIS KHOO, 9729 CAMINO REAL, ARCADIA, CA, 91007, US

(21) Appl. No.: 11/063,038

(22) Filed: Feb. 22, 2005

(51) Int. Cl. G06F 15/16

(52) U.S. Cl. 709/202

(57) ABSTRACT

A method and system is described for an electronic agent to automatically travel from an origination computer to a destination computer. The method comprises the monitoring of requests for travel, generating a list of possible destinations, determining the final destination, prioritizing the importance of the travel, and then finally inserting that traveling action into the stack. A system is further disclosed and claimed for enabling the above methodology over a data network.

### BACKGROUND OF THE INVENTION

1. Field of the Invention

The present invention relates generally to the traveling patterns of electronic agents over a data network, and more particularly to, a method and system for artificial intelligence algorithms to determine said travel patterns.

2. Description of the Related Art

Electronic agents have typically taken several forms and names in the past, including virtual pets and electronic pets, and they have performed conventional virtual pet activities. These activities include eating, playing ball, chasing objects, scratching, and other common “pet” activities.

These primitive electronic agents stay on one computer, display little intelligence, and have little interest in the activities of the user. Often, electronic agents take the form of “avatars”, virtual pets, or virtual entities on web pages. The web pages are traditionally quite static and only allow for limited interaction.

There exist several disadvantages to current electronic agent implementations.

A first disadvantage is that electronic agents exist only on the user's computer. This disadvantage means that the electronic agent is then unable to leave the user's computer to perform tasks or actions elsewhere. Because existing electronic agents are completely unaware of a greater electronic (world) around them, their limited programming prevents them from any sort of exploration, actions, or tasks outside of the user's computer.

A second disadvantage is that electronic agents are unable to interact with network events on behalf of the user. In essence, electronic agents do not “help” the user with any external activities, such as making friends, locating interesting news, making appointments, etc.

A third disadvantage is that electronic agents have limited capabilities because their wealth of knowledge is constrained to their existing programming and knowledge gained on the user's computer. They are unable to “learn” from other computers because of their isolation. The isolation means that electronic agents are unable to learn new capabilities or interact with other agents or computers in activities that might be compelling to the user.

A need therefore exists for a method and system for an intelligent traveling electronic pet that alleviates many of these disadvantages.

### SUMMARY OF THE INVENTION

The present invention provides for a method for electronic agents to travel amongst computers. The method involves a series of decisions that determine the destination of the electronic agent.

An “electronic agent” can have many manifestations. It is a software program that is seen most commonly by the user in the form of an “avatar”. The avatar can take many forms and goes by many names. Forms and names include virtual pets, virtual agents, electronic pets, or any other interactive entities on the screen that display some sort of intelligence.

Similarly, each “electronic agent” has an owner, which is also referred to in this patent as a “user”. In the preferred embodiment, the agents-to-owner have a many-to-one ratio; in that one owner can own many agents. The owner is not necessarily a human, but it can also be another software program. In another embodiment, agents can be shared by owners.

There is a two step process in determining the destination of an electronic agent. The first step is the process of deciding whether or not to travel to another computer. This decision is made via a simple algorithm that is either event-based or timer-based. The algorithm examines requests and events that may affect the electronic agent. The electronic agent may have a great number of potential activities, one of which includes traveling to another computer. If the algorithm decides that the next action will indeed be a “traveling” action, the next step is begun. The second step is the determination of the destination. Once it has already been decided that the electronic agent will be traveling, all of the possible destinations are considered and weighed accordingly.

There are many events that may cause an electronic agent to travel. Likewise, there are many reasons a user may want their electronic agent to travel on their own. The traveling decision is handled by the server AI (Artificial Intelligence) and the client AI. These two AI systems, which can either be on the same computer or different computers, often work together to ensure appropriate pet behavior and pet actions.

The server AI is responsible for slightly different decisions than the client AI, in the event that the AI is separated into different entities for client/server topology reasons. For the simplicity of example, the remainder of this text will assume that the client AI and server AI are their own separate entities on separate machines, even though that does not necessarily need to be the case.

The server AI is responsible for such decisions as examining the inherent “needs” of the electronic agent. Because the electronic agent can be some level of an autonomous entity, the AI can make decisions without any input from the user. The server AI will take into consideration both the profile of the user and the profile of the electronic agent to determine what action or behavior to undertake next. For example, the server AI may decide that the electronic agent must visit another computer to make “friends” with the owner of that computer because it has examined all the relevant profiles and determined that the owners might have a high propensity for friendship. Another example may include a situation where the electronic agent's server AI decides to send the electronic agent over to visit one or more other electronic agents so that they may begin to “play a game” together.

The client AI may make other sorts of decisions that are different from the server AI, but still connected in the sense that it affects the actions of the electronic agent. The client AI will monitor the user's behavior and pay particular attention to the user's actions. For example, the user may choose to pick up the electronic agent and drop them on another part of the screen. In another example, the user may choose to throw a tennis ball across the screen. In another example, the user may interact with their calendar and the agent to perform another set of actions. In these various examples, the pet will react accordingly, based on the decisions of the client AI. These actions would include acting annoyed, chasing a tennis ball, and running off to tell other friends about a change in the calendar. In terms of traveling, client AI may determine that an event that has transpired is so important that it requires the electronic agent to either be summoned to the client or to be expelled from the client.

The electronic agent is always subject to their stack. The stack is a queued series of actions that the electronic agent must perform seriatim. Each action takes a certain amount of time to complete. Upon completion of one of the actionable items, that item is then removed from the queue and the next item becomes the active item.

The client AI and the server AI must work with the existing stack when making decisions. After either AI makes a decision, the action item is then inserted into the stack. The insertion point is based on the weighted importance of the item. Extremely urgent action items will go be inserted close to the front of the queue or perhaps the current action item in the queue will be immediately usurped for the new urgent action item. Less important action items will either be inserted towards the rear or the end of the queue.

Another fundamental element that makes AI-determined actions possible is the event handler. The event handler can be broken down into the client event handler and the server event handler, which may or may not be separate entities. The event handler is constantly “listening” for any events. The events may emanate from network events, user events, agent events, and the like. The event handler takes the important information and passes it into the AI subroutines so they can perform the pertinent activities.

The electronic agent itself is an entity that has fundamental properties that help govern its actions. This “DNA” is the building blocks that help to form the intelligence, desires, and characteristics of the electronic agent. The electronic agent is “born” with set of characteristics that can change and evolve over time. In addition, as time continues, each electronic agent can collect a unique history of actions performs, places visited, friends made, tasks accomplished, skills learned, items gained, and the like.

The electronic agent's actions are partially dictated by its internal meters. These internal meters change over time and each one has one or more “threshold” levels. Once the meter changes enough and one of the thresholds is met, an event is spawned which then becomes the domain of the event handler. The internal meters may be connected to one another or be totally independent from one another. Examples of internal meters would include desire for food, desire for human interaction, desire to make more friends for owner, desire to make more friends for self, desire to travel to another computer, desire to play, desire to schedule activities for their owner to have more fun, desire to find a good book for their owner, etc.

The electronic agent is able to move anywhere that the data network has a connection. The destination can be any type of computer system including PCs, game console systems, handhelds, mobile devices, in-car display devices, televisions, PDA's, or any other network-enabled display device. The agent may also be sent to other non-conventional clients such as robots.

The manner in which the server and client work together is analogous to a “soul” and a “ghost”. The “soul” of the electronic agent always remains on the server. The client only receives a “ghost”, or a physical representation, of the soul. This is illustrated when the client is no longer active, the “ghost” disappears, but the “soul” persists on the server to spawn another “ghost” on a client in the future.

The electronic agent can be in more than one place at a time, or it can exist only in one discrete location at a time. If the agent can only be in one place at a time, it adds to the “believability” that an electronic agent is more analogous to a sentient being that “travels”. For example, a “Joe's” electronic agent may be a fluffy cat that may stay on a Joe's desktop for a while before leaving and traveling to a Joe's girlfriend's desktop to play with her electronic-agent.

The electronic agent acts as a proxy for the user. The user may be very busy doing other tasks and may choose to allow the electronic agent to perform certain tasks for them. Another possibility is that the user is unaware of various possibility spaces that might exist for them, whereas their agent will constantly explore these possibility spaces on their behalf.

For example, the electronic agent may be a facilitator for an electronic social network. An electronic social network is a software program that enables various parties in multiple locations to create acquaintances, friendships, business contacts, or romantic connections. One problem with social networking is that users may be shy, unaccustomed, or unskilled at expanding their own social network. These problems can be mitigated by an electronic agent that is actively traveling across the network to grow the user's social network on the user's behalf. As has already been detailed, the electronic agent makes traveling decisions based on the user profile, so it may do an excellent job of finding potential expansion points for the social network. If the electronic agent took the form of a cute pet, it can visit other social networking “candidates” in a proactive yet non-intrusive manner. The premise is that a user is much more amiable to a cute cat visiting their screen to make friends than a text-message friend request. Thus, allowing pets to make friends on a user's behalf is a much more effective method for expanding a user's social network.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a block diagram view of the preferred embodiment of the present invention;

FIG. 2 is a flow chart of an embodiment of the method of the present invention;

FIG. 3 is a block diagram view of an embodiment of the server of the present invention;

FIG. 4 is a block diagram view of an embodiment of the artificial intelligence services of the present invention;

FIG. 5 is a flow chart of an embodiment of the method of the present invention;

FIG. 6 is a flow chart of an embodiment of the method of the present invention; and

FIG. 7 is a block diagram view of a general purpose computer that may be used to implement an embodiment of the method and system of the present invention.

### DETAILED DESCRIPTION OF THE PREFERRED EMBODIMENTS

System Overview

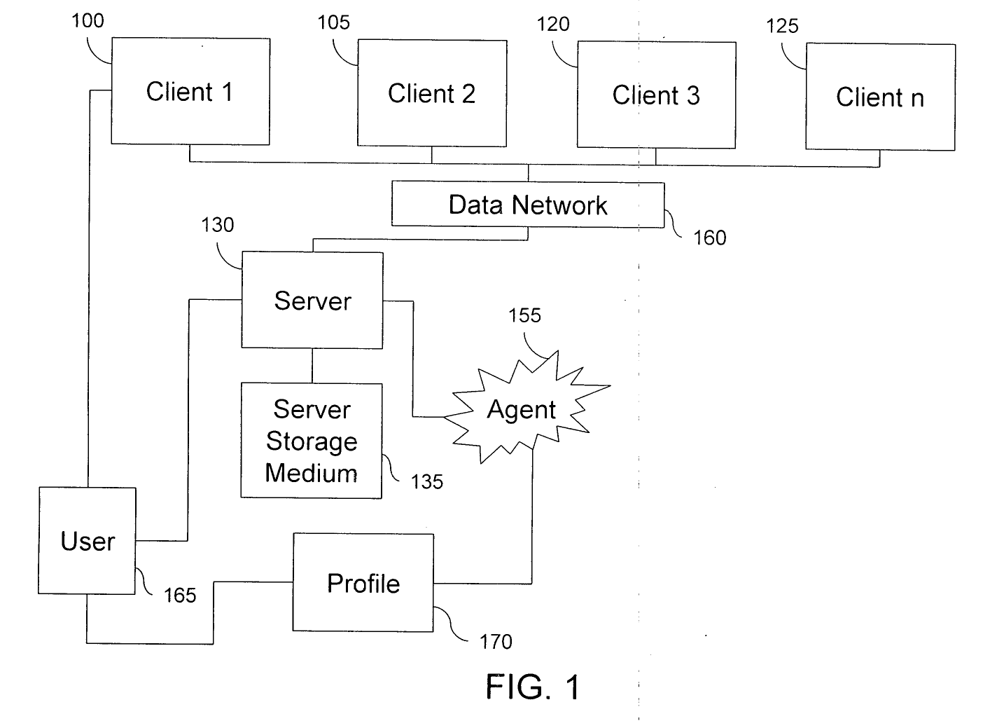

FIG. 1 is a block diagram view of an embodiment of the computer system of the present invention. In FIG. 1, a computer system is shown to have an electronic agent 155 that is associated with a server 130. The server 130 is associated with a one or a plurality of clients (100, 115, 120, 125). Any client (e.g. 100) can receive the agent 155 via the server 130. The server 130 decides the destination of the agent 155. The agent 155 may then exist on one or more clients 100. The server 130 or the origin client may decide that the agent should travel to another client (100, 115, 120, 125). Upon leaving the origin client, the agent then travels to the destination client (100, 115, 120, 125), until which time the server 30 or client decides the agent needs to travel again.

The client 100 may take many manifestations 135 besides a traditional computer. These manifestations 135 include, but are not limited to, handheld computers, mobile phone, wireless devices, and the like.

The server storage medium 135 may be any type of storage device as are well known in the art, for example, any type of disc including hard disc, flash memory, micro drives, hard drives, floppy disc, optical disc, DVD, CD-ROMS, magnetic optical discs, RAM, EPROM, EEPROM, magnetic or optical cards, or any type of storage media that is suitable for storing electronic instructions/data. The server storage medium 135 may reside on the same physical system as the server 130.

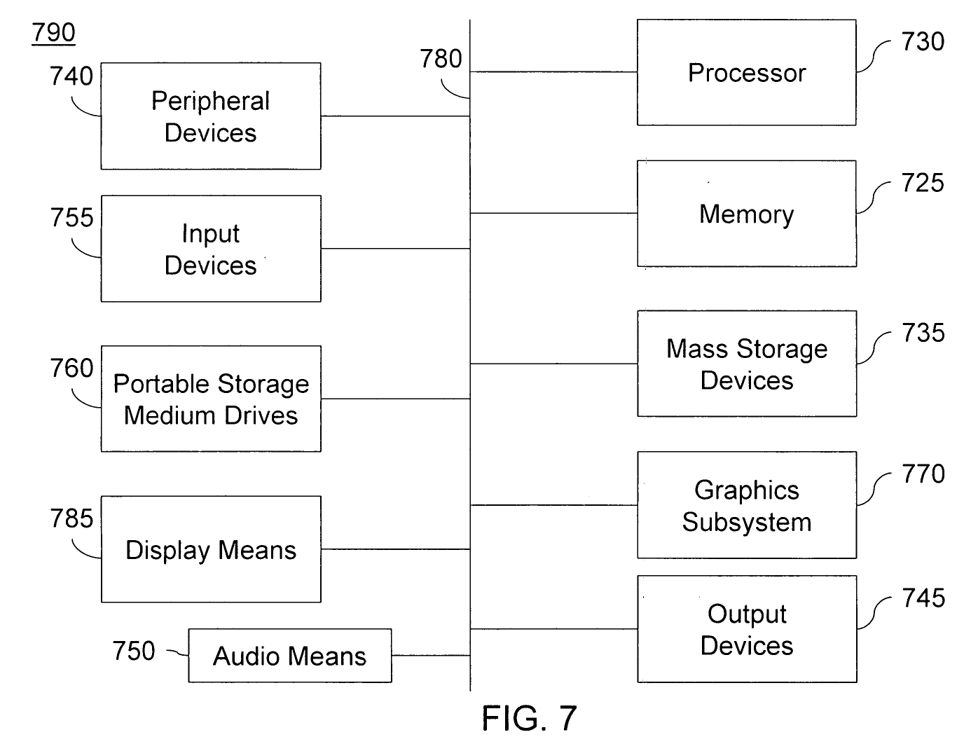

It is noted that the computer system, as shown in the embodiment of FIG. 1, shows a server 130 and client 100 as two separate general purpose computers (FIG. 7). However, as is apparent to one skilled in the art, the server 130 and client 100 connected by the data network may, in fact, be a single general purpose computer, where the data network is a bus (FIG. 7) rather than a data network such as the Internet. That is, while the embodiment of FIG. 1 shows the server and client as separate entities, those entities may in fact be one general purpose computer as shown in FIG. 7.

Still in FIG. 1, a data network connects the server 130 and the client 100. The data network may be an Internet, an Intranet, an Extranet, a wireless connection, an ethernet-type bus, or any type of connection that is able to transfer data between the server 130 and client 100. In one embodiment, the data network is the Internet, where data is transmitted from different geographical locations where the server 130 and the client 100 are located. The server 130 includes a server processor (not shown), which may be any well-known central processing unit (CPU) or a microprocessor (whether a single microprocessor or a plurality of microprocessors). The server's 130 processor, in one embodiment of the present invention, generates a series of actions for the electronic agent 155 based on the profile of the user 325 and/or the profile of the electronic agent 320. Thus, as more fully described below, a user 165 will provide personalized data, in the form of a profile 170, via the client 100.

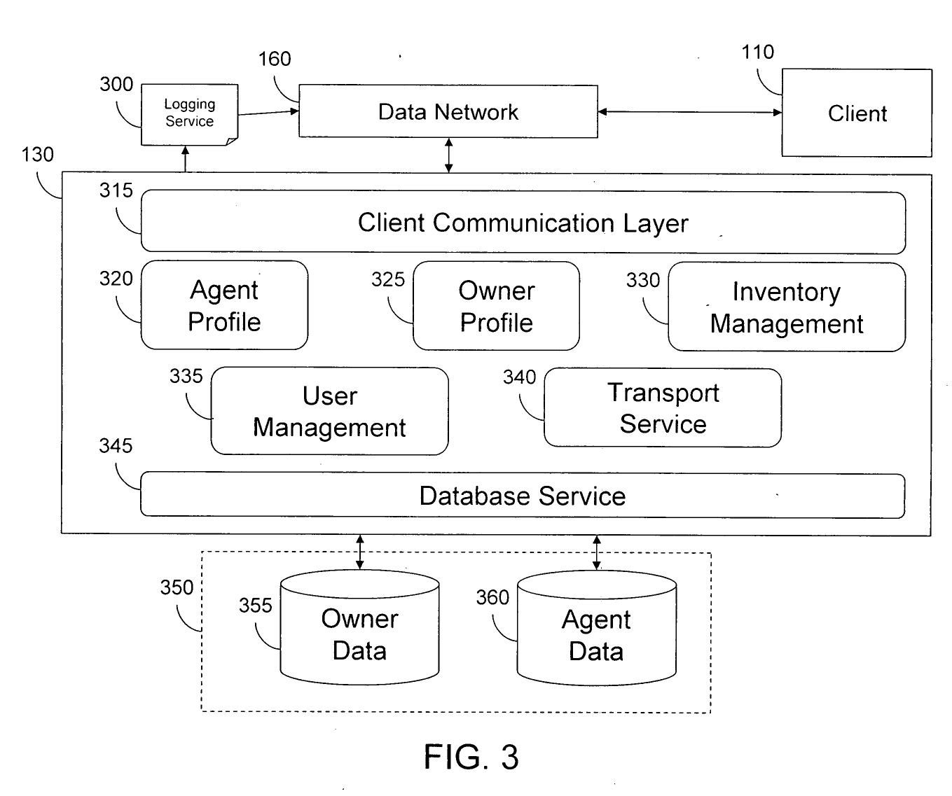

FIG. 3 shows the preferred embodiment of the server system 130. The server 130 is the heart of the system that determines the agent's 155 behavior and traveling patterns. The server 130 contains a variety of services that add to the functionality of the electronic agent 155. The fundamental services include the agent profile 320, a service that is responsible for keeping track of all of the activities, needs, desires, history, and extended profile data of the electronic agent 155; the owner profile 325, a service that is responsible for keeping track of all the activities, needs, desires, hobbies, interests, characteristics, attributes, history, and extended profile data of the owner; the inventory management 330, a service that maintains a list of all of the objects the various agents and owners can utilize; the user management 335, a service that maintains account information for the user and pertinent account and billing activity; and the transport service 340, a service that enables services to communicate with one another. Layered on top of these basic services are the database service 345 and the client communication layer 315. The database service enables the server to access the databases 350 including the owner data 355 and the agent data 360. The owner database 355 is commonly the domain of the owner profile 325 service. The agent database 360 is commonly the domain of the agent profile 320 service.

The logging service 300 maintains a log of server 130 activities and can be adjusted by the administrator to log whatever information is pertinent that stems from client and/or server activities.

The client communication layer 315 is the common service that acts as the interface between the client and the server. This directly interfaces with the data network 160, which in turn maintains a connection to the client 100.

The server 130, in another embodiment, can perform a great deal more services other than the basic ones described above. The server may be utilized by agents to perform a variety of services that prove to be beneficial to the owner 165 or to the agent program itself. Such services include shopping, making appointments, blogging, playing games, and other extended services.

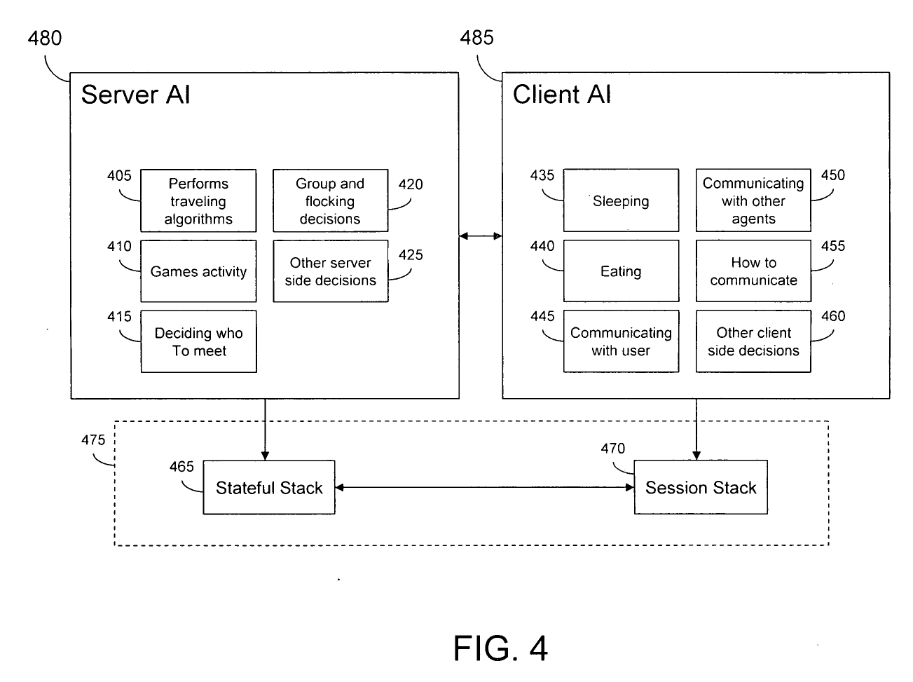

FIG. 4 is a block diagram representation of the preferred embodiment for the artificial intelligence (AI) engine. Because the electronic agent 155 is an entity that is stored on the server 130, but often spends time on various clients 100, it is necessary to have various levels of AI working together in concert. As has been stated, because the client 100 and server 130 can indeed be one general purpose computer, these AI pieces can be one in the same.

The server 130 has a service running that is called the Server AI 480. The server AI 480 is responsible for many activities that govern the behavior and activities of the electronic agent 155. The server AI 480 is largely responsible, but not solely responsible, for determining the traveling destinations of the agent 155. It performs this via the traveling algorithms 405. The server AI 480 performs many other important stateful activities including games activity 410, a decision which may require the agent's presence within a game session; deciding who to meet 415, a social networking decision; group and flocking decisions, a series of parameters that determine if an agent should join other agents in a particular location; and other server side decisions 425. Once these decisions are made and the server 130 decides on an activity or behavior, that activity is placed in the stateful stack 465. The stateful stack 465 is a server-side stack that maintains its state even when no client activity is registered. The stateful stack 465 differs from the session stack 470 in that the session stack 470 disappears whenever the client 100 is logged off.

Similar to the server AI 480, the client AI 485 is responsible for decisions affecting the actions and behaviors of the electronic agent 155. These decisions are more related to specific client-side activities and are often specific to interactions with the owner 165.

The client AI 485 is only active when the client 100 is active. When the client 100 is “on”, a session begins. The session will perform a series of actions with the electronic agent 155. The session will continue to make decisions while the client 100 is on. These decisions are determined by the client AI 485, and then placed into the session stack 470. The session stack 470 will also receive new items from the server 130, which is responsible for determining the stateful actions which originate from the stateful stack 465.

The client AI 485 can perform several decisions that do not relate to any permanent “state”. These decisions include items such as sleeping 435, eating 440, communicating with user 445, communicating with other agents 450, how to communicate 455, and other client side decisions 460.

Once the client 100 is no longer active, including being offline and turned off, the session stack 470 is emptied.

Certain activities that are inserted into the session stack 470 by the client AI 485 can also be replicated onto the server 130 and inserted into the stateful stack 465.

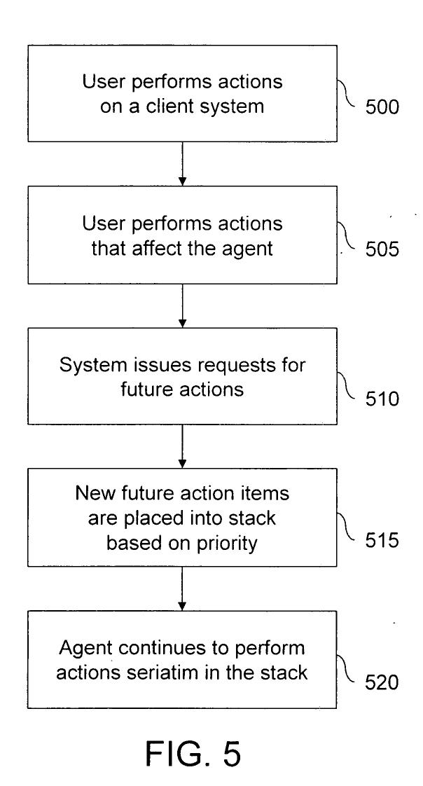

FIG. 5 illustrates a preferred embodiment of a process flow of the present invention. The overall concept is one where an electronic agent acts as a semi-autonomous entity that intelligently performs actions, local and remote, on behalf of the user.

The process begins with the user performing actions on a client system 500. It is assumed that these actions are performed while the electronic agent 155 is activated. The user then performs actions that affect the agent 505. The system, which is governed by AI algorithms, then issues requests for future actions 510. These activities are then placed into the stack based on priority 515. Finally, the agent performs actions seriatim in the stack 520.

FIG. 7 illustrates a high-level block diagram of a general purpose computer which is used, in one embodiment, to implement the method and system of the present invention. The general purpose computer, in one embodiment, acts as either the server 130 or client 100 of FIGS. 1, 3 and 4 above. The general purpose computer of FIG. 7 includes a processor 730 and memory 725. Processor 730 may contain a single microprocessor, or may contain a plurality of microprocessors, for configuring the computer system as a multi-processor system. In alternative embodiments described above, the processor 730 includes the server processor and client processor of FIGS. 1, 3 and 4 above. Memory 725, stores, in part, instructions and data for execution by processor 730. If the system of the present invention is wholly or partially implemented in software, including computer instructions, memory 725 stores the executable code when in operation. Memory 725 may include banks of dynamic random access memory as well as high speed cache memory.

The computer of FIG. 7 further includes a mass storage device 735, peripheral device(s) 740, audio means 750, input device(s) 755, portable storage medium drive(s) 760, a graphics subsystem 770 and a display means 785. For purposes of simplicity, the components shown in FIG. 1 are depicted as being connected via a network (i.e. transmitting means). However, the components may be connected through a bus 780 on a single general purpose computer. For example, processor 730 and memory 725 may be connected via a local microprocessor bus, and the mass storage device 735, peripheral device(s) 740, portable storage medium drive(s) 760, and graphics subsystem 770 may be connected via one or more input/output (I/O) buses. Mass storage device 735, which is typically implemented with a magnetic disk drive or an optical disk drive, is in one embodiment, a non-volatile storage device for storing data and instructions for use by processor 730. The mass storage device 735 includes the storage medium of embodiments of the present invention, and the server storage medium and client storage medium in alternative embodiments. In another embodiment, mass storage device 735 stores the first and second algorithms of the server in an embodiment of the present invention. The computer instructions that implement the method of the present invention also may be stored in processor 730.

Portable storage medium drive 760 operates in conjunction with a portable non-volatile storage medium, such as a flash memory, wireless storage device, floppy disk, or other computer-readable medium, to input and output data and code to and from the computer system of FIG. 7. In one embodiment, the method of the present invention that is implemented using computer instructions is stored on such a portable medium, and is input to the computer system 790 via the portable storage medium drive 760. Peripheral device(s) 740 may include any type of computer support device, such as an input/output (I/O) interface, to add additional functionality to the computer system 790. For example, peripheral device(s) 740 may include a network interface card for interfacing computer system 790 to a network, a modem, and the like.

Input device(s) 755 provide a portion of a user interface. Input device(s) 755 may include an alpha-numeric keypad for inputting alpha-numeric and other key information, or a pointing device, such as a mouse, a trackball, stylus or cursor direction keys. Such devices provide additional means for interfacing with the customized media list and the customized media in the method of the present invention. In order to display textual and graphical information, the computer of FIG. 7 includes graphics subsystem 770 and display means 785. Display means 785 may include a cathode ray tube (CRT) display, liquid crystal display (LCD), other suitable display devices, or means for displaying, that enables a user to view the customized media list or customized media. Graphics subsystem 770 receives textual and graphical information and processes the information for output to display 785. The display means 785 provides a practical application for providing the customized media list of the present invention since the method of the present invention may be directly and practically implemented through the use of the display means 785. The computer system of FIG. 7 also includes an audio system 750. In one embodiment, audio means 750 includes a sound card that receives audio signals from a microphone that may be found in peripherals 740. In another embodiment, the audio system 750 may be a processor, such as processor 730, that processes sound. Additionally, the computer of FIG. 7 includes output devices 745. Examples of suitable output devices include speakers, printers, and the like.

The devices contained in the computer system of FIG. 7 are those typically found in general purpose computer, and are intended to represent a broad category of such computer components that are well known in the art. The system of FIG. 7 illustrates one platform which can be used for practically implementing the method of the present invention. Numerous other platforms can also suffice, such as Macintosh-based platforms available from Apple Computer, Inc., video game platforms such as handheld devices from Nintendo (like the Nintendo DS) and from Sony (like the Sony PSP), platforms based on mobile phones that feature graphical user interfaces, platforms with different bus configurations, networked platforms, multi-processor platforms, other personal computers, workstations, mainframes, navigation systems, and the like.

In a further embodiment, the present invention also includes a computer program product which is a computer readable medium (media) having computer instructions stored thereon/in which can be used to program a computer to perform the method of the present invention. The storage medium can include, but is not limited to, any type of disk including flash memory, hard disks, floppy disks, optical disks, DVD, Writable DVDs, CD ROMs, magnetic optical disks, RAMs, EPROM, EEPROM, magnetic or optical cards, or any type of media suitable for storing electronic instructions.

### COMPREHENSIVE EXAMPLE

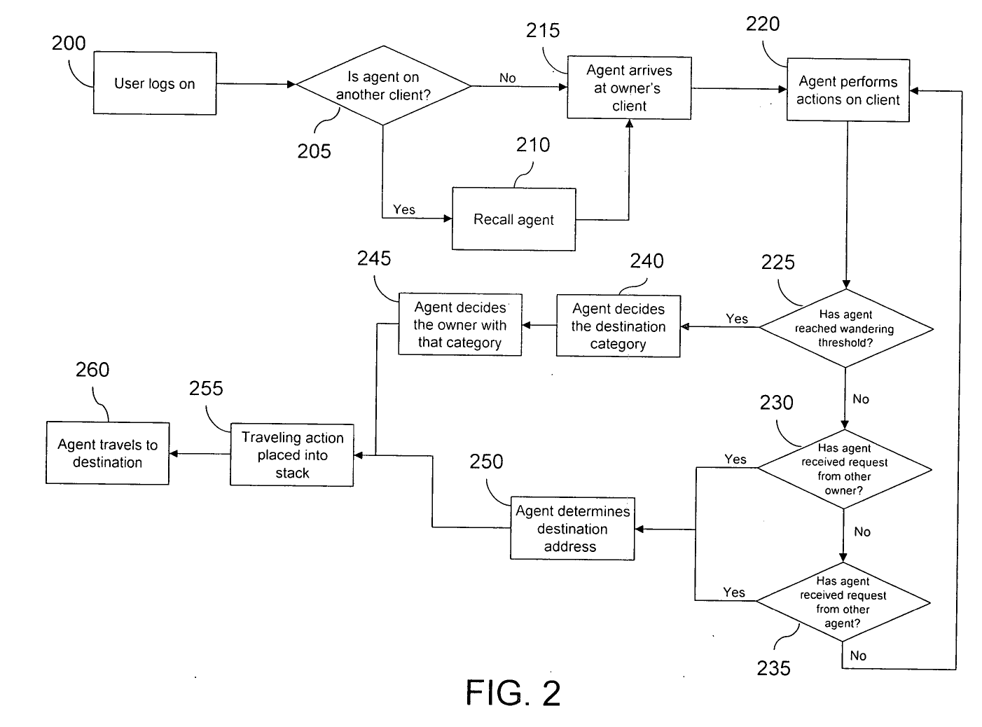

FIG. 2 is a flow chart of an embodiment of the method of the present invention. In FIG. 2, the comprehensive example of one embodiment of the methodology and system of the present invention begins at step 200 where a user, such as user 165 of FIG. 1, logs on to the client 100 that runs the application that enables the electronic agent 155.

Once the client 100 is running after step 200, the client 100 then determines if the electronic agent 155 is currently on another client 205. If the electronic agent 155 is indeed on another computer, then the client 100 recalls the agent 210. After this event, or in the case of a negative response from 205, step 215 begins when the agent is shown appearing on the user's client.

The user then continues to perform actions on the client 100 which may or may not affect the status of the electronic agent 155. This “cycle” of the user performing actions is covered by step 220. As the user performs actions, the event handler 640 continues to build up a series of activities to perform. Some of these activities may or may not have to do with traveling to another computer. As this comprehensive example describes traveling, only those activities and decisions based on traveling are germane.

In this embodiment, the electronic agent 155 has three different possibilities that can affect its traveling status. The first traveling check is made against the internal threshold for desire to wander in step 225. This can be further described as the electronic agent's inherent needs and desires to travel. This desire can increase over time while the agent is not traveling. It operates similar to “hunger”, where if the agent does not eat any food for a long time, it will become hungrier. Upon reaching a predefined threshold level, the agent will begin to seek to remedy that “hunger” automatically. In this case the “hunger” is the desire to travel. If that level is reached in 225, they move on to step 240.

In step 240, the agent decides on a destination category. There are a variety of traveling categories that indicate the destination preferences as indicated in profile 170. Preference categories include friends, friends of friends, random, custom, and friends of the agent itself. The user has some or total control over how these preferences are weighed and prioritized.

Once a category is decided in step 240, step 245 determines exactly which owner to visit within that category. It begins with the substep of examining the list of all the owners within the destination category. Note that in another embodiment, the owners in the destination category may not want to be visited by the given electronic agent for a variety of reasons. These reasons can include but are not limited to specific barring of a particular agent, general filter that filters out agents that fall into a certain category, or the client is too full of existing agents or to busy to support additional agents. After the list is examined, the list is sorted into a preference order and a scattering algorithm determines the final choice that weights by preference.

Once the destination is decided in 245, the traveling action is placed into the stack in 255. If the traveling action is urgent, it may be placed first in the stack. If the agent is busy performing higher priority tasks, it may place the item further down the stack. Finally, in step 260, the agent arrives at the destination.

If the agent has not reached the wandering threshold in step 225, there is a check to see if there has been a request from another owner in step 230. There are many events that might transpire to precipitate this activity, including the new online arrival of an agent's “friend”, a specific request from another owner, or activity at another location that requests the presence of an agent. This final possibility is mentioned more specifically in step 235, when an agent receives a request from another agent.

If either of these steps 230 or 235 are true, then step 250 ensues where the agent determines the destination address. This is a specific location based on the origination of the request, so there is no need to perform the algorithms described in steps 240 and 245.

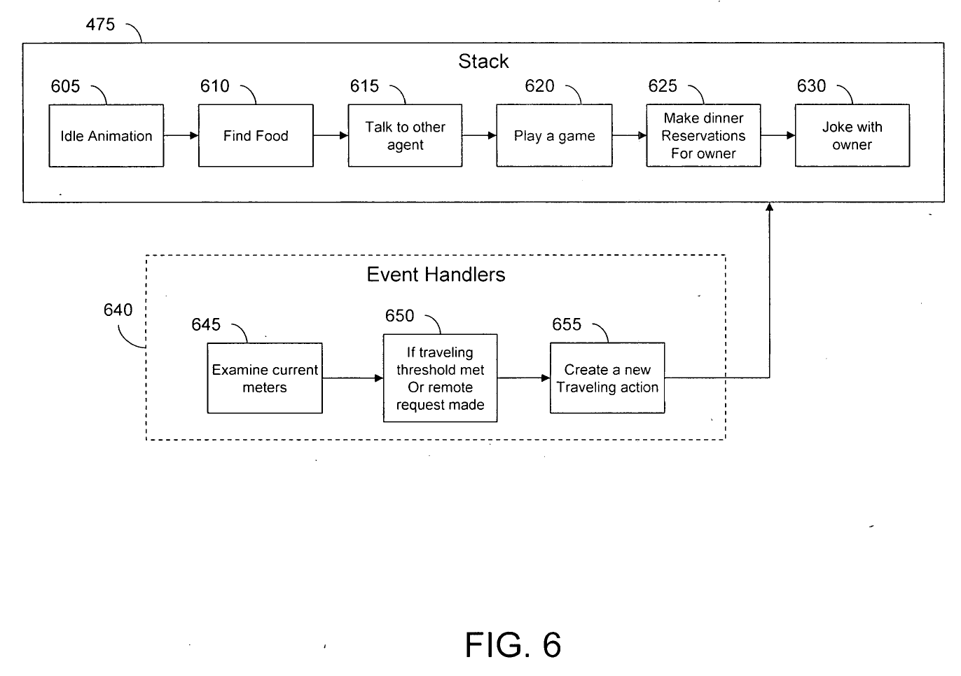

FIG. 6 illustrates a possible embodiment of the present invention in terms of how it handles the stack. The stack 475 contains a series of activities that are in the queue for the electronic agent 155 to perform. In this example, the server AI 480 and or the client AI 485 has determined actions to be placed onto the stack. The first item to be performed in the stack is an idle animation 605, followed by a finding food action 610, followed by talking to another agent 615, followed by playing a game 620, followed by making dinner reservations for the owner 625, followed by joking with the owner 630, followed by other tasks.

The current action being performed is the action at the beginning of the stack. In the example in FIG. 6, the current action is idle animation 605. Each action may take only an instant to perform, while others may take several seconds, minutes, hours, or days. It is possible for the current action to be a plurality of actions. For example, the agent may be able to make dinner reservations while playing a game with the user.

The event handler 640, is constantly monitoring all events 645 and then choosing the appropriate location for insertion into the stack 475. In this example, the stack is examining all the current meters of the electronic agent 155. These meters may include but are not limited to thirst, hunger, desire for human interaction, desire for interaction with another agent, desire to travel, desire to play, desire to help their user be more healthy, boredom, and the like.

If, while monitoring current meters 645, the traveling threshold has been met or a remote request has been made 650, then the event handler will create a new traveling action 655. Every action has a priority attached to it, so there will then be a prioritized placement into the existing stack.

Although the present invention has been described in detail with respect to certain embodiments and examples, variations and modifications exist which are within the scope of the present invention as defined in the following claims.

What is claimed is:

1. A method for an electronic agent to travel across an electronic network from a source client system to a destination client system, said method comprising the steps of:
creating said electronic agent by the electronic agent owner;
displaying said electronic agent on said source client system, where said source client system is connected to said electronic network;
determining the destination client system for said electronic agent to travel, where said destination client system is connected to said electronic network; and
displaying said electronic agent on said destination client system.

2. The method of claim 1 wherein said electronic agent is a virtual pet.

3. The method of claim 1 wherein said electronic agent is a cartoon character.

4. The method of claim 1 wherein said electronic network is the internet.

5. The method of claim 1 further comprising the step of:
hiding said electronic agent from said source client system.

6. A method for an electronic agent to determine the next destination of travel, said method comprising the steps of:
creating a profile for the owner of said electronic agent;
creating said electronic agent by said owner;
determining a new destination;
inserting said new destination into a prioritized queue of future destinations; and
determining said next destination by selecting the highest priority destination from said prioritized queue of future destinations.

7. The method of claim 6 wherein the step of determining a new destination is based on said profile.

8. The method of claim 6 wherein the step of determining a new destination is based on a request by said owner.

9. The method of claim 6 wherein the step of determining a new destination is based on a request by another owner of another electronic agent.

10. The method of claim 6 wherein the step of determining a new destination further comprises the substep of determining the priority for said new destination.

11. The method of claim 6 wherein the step of determining a new destination further comprises the stubsteps of:
generating a list of possible destinations for said electronic agent; and
selecting said new destination from said list of possible destinations.

12. The method of claim 6 wherein said electronic agent is a virtual pet.

13. The method of claim 6 wherein said electronic agent is a cartoon characters.

14. The method of claim 6 wherein said electronic agent is a photo-realistic representation of said owner.

15. The method of claim 6 wherein said electronic agent has an electronic agent profile.

16. The method of claim 15 wherein the step of determining a new destination is based on said electronic agent profile.

17. A system for traveling by an electronic agent comprising:
a source client terminal to display said electronic agent before said electronic agent has traveled;
a destination client terminal to display said electronic agent after said electronic agent has traveled;
a server, containing a storage medium capable of storing the profile of said electronic agent and a destination queue, said server responsible for processing said electronic agent's next destination based on said profile of said electronic agent; and
a data network connecting said server, said source client terminal and said destination client terminal

18. The method of claim 17 wherein said destination client terminal and said source client terminal are desktop computers.

19. The method of claim 17 wherein said data network is the internet.

20. The method of claim 17 wherein said electronic agent is a virtual pet.
